(19) United States
(12) Patent Application Publication
(10) Pub. No.: US 2007/0116255 A1
(43) Pub. Date: May 24, 2007

(54) Echo canceller having a series arrangement of adaptive filters with individual update control strategy

(75) Inventors: Rene Martinus Maria Derkx, Eindhoven (NL); Ivo Leon Diane Marie Merks, Eindhoven (NL); Cornelis Pieter Janse, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,319

(22) PCT Filed: Nov. 25, 2004
(86) PCT No.: PCT/IB04/52556

§ 371 Date: Jun. 9, 2006

(30) Foreign Application Priority Data
Dec. 10, 2003 (EP) 03104614.7

(51) Int. Cl. H04M 9/08

(52) U.S. Cl. 379/406.08

(57) ABSTRACT

Disclosed is an echo canceller comprising two or more adaptive filters for calculating echo estimates, whereby the adaptive filters each have adaptation control mechanisms for applying individual update control criteria. The adaptive filters are arranged in series. Each of the adaptation control mechanisms of the adaptive filters may apply individual update control criteria for both direct echo and diffuse echo. Several step-size reduction strategies are presented.

The present invention relates to an echo canceller comprising two or more adaptive filters for calculating echo estimates, the adaptive filters each having adaptation control mechanisms for applying individual update control criteria

The present invention also relates to a telephone, in particular a mobile telephone, provided with such an echo canceller.

Such an echo canceller is known from an article entitled: “Step-Size Control For Acoustic Echo Cancellation Filters—An Overview”, by A. Mader, et al, Signal Processing 80 (2000), pages 1697-1719. The known echo canceller discloses a parallel arrangement of an adaptive-reference-echo canceller filter and an adaptive-shadow-echo canceller filter. Both filters are adapted similarly, but with different step sizes and the parallel shadow filter is adapted to the loudspeaker enclosure microphone system, such as used in hands-free telephones. The adaptation control mechanism of the shadow filter is arranged such that adaptation is stopped if a remote or loudspeaker signal falls below a predetermined threshold. Furthermore only half or less of the number of coefficients is used for the shadow filter, in comparison to the reference filter. Adaptation control is such that in case of enclosure dislocations the shadow filter is better adjusted to the loudspeaker enclosure microphone echo path than the reference filter.

It is an object of the present invention to provide a further developed echo canceller which is robust to near end speech, in particular as arising in mobile telephones during hands-free operation.

Thereto in the echo canceller according to the invention at least two of the adaptive filters are arranged in series.

Advantageously the echo canceller according to the invention uses an echo cancelled output signal of the first adaptive filter to further cancel echoes by means of the second or possibly further adaptive filter. This way of peeling off the echoes from a microphone signal results in an improvement of robustness of the echo canceller according to the invention to near end speech, as well as double talk. This favours application of the echo canceller according to the invention in situations of strong echoes in comparison with desired near end speech, as in telephones, possibly equipped with hands-free devices. Each of the adaptive filters may apply its own individualised update time control strategies, which may dependent for instance on the expected kind of echo, such as the echo signal strength given the applications concerned.

An embodiment of the echo canceller according to the invention is characterised in that a first adaptive filter is arranged for cancelling an echo part, and the second adaptive filter is arranged for cancelling at least a remaining echo part.

A dividing of an echo field into two or possibly more different parts allows for tailoring the update control criteria of each of the adaptive filters for cancellation different echo parts in order to optimise echo cancelling.

In a practical implementation the echo canceller according to the invention is characterised in that the echo canceller includes a delay element which is coupled to a second or further adaptive filter.

A preferred embodiment of the echo canceller according to the invention is characterised in that the first adaptive filter is arranged for cancelling a direct echo, and the second adaptive filter is arranged for cancelling a diffuse echo.

Generally the direct echo part includes a direct echo signal from a loudspeaker to the microphone, and possibly includes one or more first reflections of the loudspeaker signal to a surrounding and then to the microphone. The diffuse echo part, that is the exponentially decaying reverberant tail of the echo impulse response is generally effected by movements of the hand-held audio equipment within a room. Now advantageously even direct echo parts may be treated differently from diffuse echo parts, which is in particular important in those situations wherein such echo parts and/or their origin can be distinguished in the total echo field, such as the case in mobile phone equipment.

A still further embodiment of the echo canceller according to the invention is characterised in that the echo canceller comprises threshold means coupled to at least one of the adaptation control mechanisms for reducing the respective step-size if the spectral power of near end speech fed to the echo canceller exceeds a respective threshold level.

In this embodiment an individualised slowing down or reduction of the step-size by the control mechanism can be achieved for effective robust reduction of at least one out of the several distinguished echo parts.

Still another embodiment of the echo canceller according to the invention is characterised in that the threshold level which is applied in the adaptation control mechanism for the direct and/or diffuse echo part is dependent on the spectral power of a far end signal fed to the echo canceller.

This way the far end signal is taken as an estimate which comprises a measure for the direct echo sensed by a microphone concerned. For instance the dependency may be linear by means of an adjustable coupling factor.

Another embodiment of the echo canceller according to the invention is characterised in that the threshold level for direct echo cancelling is related to the spectral power of the far end signal multiplied by an echo reduction function.

The echo reduction function may for example start at a value of one and if gradually made smaller this will lead to a complying with a step-size slowing down condition at lower spectral power values of the wanted near end speech than it was originally the case. In general the echo reduction function may be measured and adjusted accordingly, in particular during convergence of the adaptive filter concerned or upon movement or change of echo path or position of microphone and/or loudspeaker.

At present the echo canceller according to the invention will be elucidated further together with its additional advantages, while reference is being made to the appended drawing, wherein similar components are being referred to by means of the same reference numerals. In the drawing:

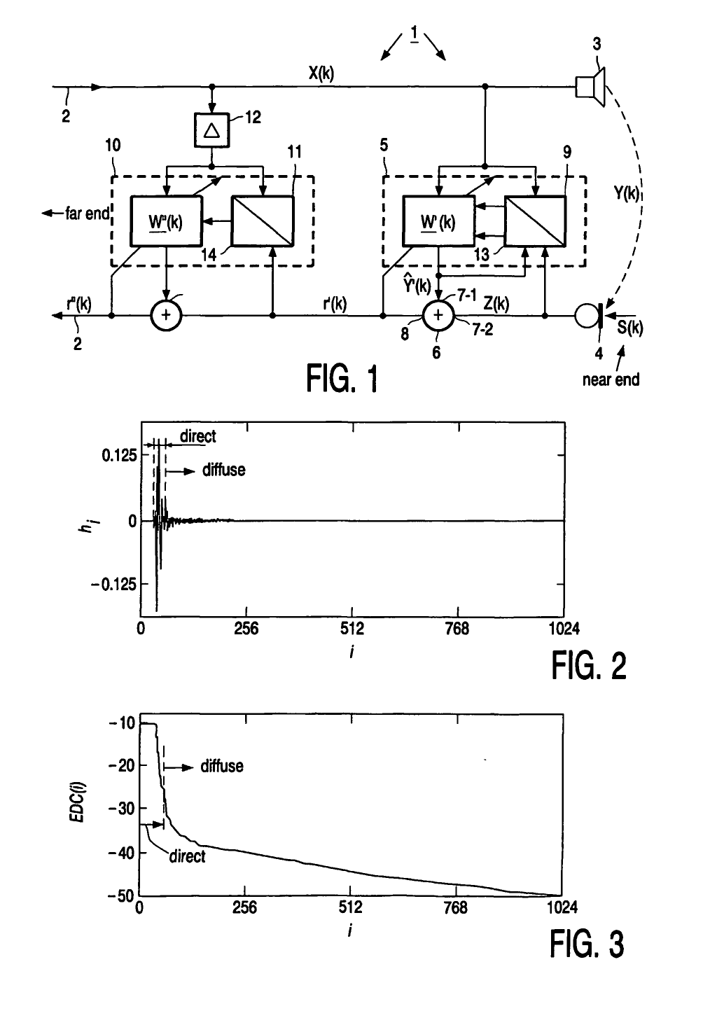

FIG. 1 shows an embodiment of the echo canceller according to the invention;

FIG. 2 shows a graph of a digital acoustic impulse response h(i) in a typical mobile telephone; and

FIG. 3 shows a graph of the Energy Decay Curve (EDC) of the digital impulse response of FIG. 2.

FIG. 1 shows an outline of an embodiment of an echo canceller 1 applicable in telecommunication devices, such as for example audio devices, in particular telephones possibly of the known hands-free type. Specifically one-near-end of a communication line 2 is depicted in FIG. 1, the other end is called the far end. A far end digital time domain signal x(k), where k indicates the sample index with k=1, 2, . . . , is fed to a loudspeaker 3 via an appropriate digital to analog device and an amplifier (not shown). The signal is then heard by a person and in particular in those applications where loudspeaker 3 and a microphone 4 are close together, or if a speakerphone is activated a part y(k) will be sensed by the in this case one microphone 4. In fact the signal y(k) is a convolution of x(k) and h(k), the latter being the impulse response of the housing and/or room wherein the device is positioned. However apart from noise the microphone 4 also senses speech s(k) from the near end speaker. A microphone signal z(k) includes a combination of all signals sensed by the microphone 4. The echo canceller I comprises a first adaptive filter 5 to which the signal x(k) is input and a adder 6, having a negative input 7-1 carrying a filter output signal ŷ(k) which adder 6 is coupled to the filter 5, having a positive input 7-2 carrying the signal z(k) which is coupled to the microphone 4, and having an output 8 carrying an adder output signal r′(k). The first adaptive filter 5 functions in a known way. The adaptive filter 5 has N filter coefficient vectors each denoted by w′(k), which are updated during each sample index k, such that after convergence these N filter coefficients denote a finite version of the real impulse response h(k). In accordance with this electric acoustic echo model the discrete convolution above is described by:

$${\hat{y}}^{′} ( k ) = {\sum }_{n = 0}^{N - 1} {\underline{w}}^{′} ( n ; k ) \times ( k - N ) \qquad ( 1 )$$

The adder output signal r′(k)=z(k)−ŷ′(k) now contains the echo cancelled signal. Several strategies can be applied to minimize the echo by minimizing the spectral power P_{r′r′}(k) of the so called residual signal r′(k). Known strategy examples to be implemented are Affine Projection Algorithms (APA), Frequency Domain Adaptive Filtering (FDAF), and Sub-band Adaptive Filtering (SAF).

For example the Normalised Least Mean Square (NLMS) is formulated as:
w′^{N}(k+1)=w′^{N}(k)+α(k)r′(k) x^{N}(k)/|x^{N}(k)| (2)
wherein α(k) is the adaptation constant, also called the stepsize of the adaptive filter 5, which lies in the range between 0 and 2. In the so called Wiener state the filter coefficients are optimal. The higher the values for α(k) the faster the adaptation process converges to the Wiener state, but if arrived in this state the coefficients will then fluctuate more, resulting in so called misadjustments. In addition the presence of desired speech s(k) acts as a disturbance to the adaptation process. The echo canceller 1 comprises an adaptation control mechanism 9, wherein the adaptation strategy, in particular the step-size and update frequency are being controlled in order to cope with conflicting requirements with regard to optimisation of the convergence speed at the one hand and optimisation of robustness in the presence of desired speech at the other hand. Generally there are several types of adaptation control techniques, in particular step-size control strategies.

FIG. 2 shows a graph of a digital acoustic impulse response regarding a kind of echo to be expected in a typical mobile telephone. It turns out that a rather clear transition between a direct part and a diffuse part of the impulse response can be distinguished. This transition is clearer if loudspeaker 3 and microphone 4 are positioned more closely together. This transition is therefore at least approximately a-priori known. This knowledge is applied in the echo canceller 1 by having the filter 2 cancel a first—in particular direct echo impulse part and coupling a second adaptive filter 10 in series with the filter 5, which second filter cancels a remaining echo part. The second filter 10 has an adaptive control mechanism 11 which applies its own adaptation strategy, in particular the step-size and update frequency. This strategy is optimised for cancelling the remaining echo part, in particular the diffuse echo part which comprises less energy than the direct echo part, which is shown in FIG. 3. The individual adaptation control strategies applied in the respective filters 2 and 10 may be the same, or different from one another.

One step-size control method uses a-priori information about the coupling between loudspeaker 3 and microphone 4. Assuming the signals y(k) and s(k) are uncorrelated, the inverse step-size may then be defined by:
α⁻¹(k)=1+Pₛₛ(k)/P_{yy}(k). (3)

In practice one takes the spectral power P_{r′r′}(k) (generally adder output signal) instead of Pₛₛ(k), and C′ Pₓₓ(k) instead of P_{yy}(k) where C′ is some adjustable coupling function. This only leads to a small degradation in convergence speed. This method could be implemented in one of the filters 2 and/or 10 for cancelling the direct or diffuse echo part respectively.

Another step-size control method uses a-priori information about the coupling between loudspeaker 3 and microphone 4, as well as information about the echo reduction by the adaptive filters 5, 10 themselves. Similarly the inverse step-size may then be defined by:
α⁻¹(k)=1+Pₛₛ(k)/P_{εε}(k). (4)
where ε(k)=y(k)−ŷ′(k). Again this method could be implemented in one of the filters 5 and/or 10 for cancelling the direct or diffuse echo part respectively.

It is preferred to implement equation (4) above in the adaptive direct echo filter 2, and to implement equation (3) above in the adaptive diffuse echo filter 10. In order to skip the modelling of the direct echo field in the second filter 10 the echo canceller 1 comprises an appropriate delay element 12.

The echo canceller 1 may comprise threshold means 13, 14 coupled to one or both of the adaptation control mechanisms 9, 11 for reducing a step-size concerned if the spectral power of the near end speech signal s(k) fed to the echo canceller 1 exceeds a respective threshold level. For example the adaptation step-size for direct or diffuse echo cancelling could be slowed down when Pₛₛ(k) exceeds a threshold level of C′ Pₓₓ(k), or C″ Pₓₓ(k), respectively, where again C′ and also C″ are adjustable coupling functions. In those cases the threshold levels are dependent on the spectral power of the far end signal x(k) fed to the echo canceller 1. When large direct echoes dominate the near end speech s(k) the adaptation of the direct field by the adaptation control mechanism 9 in the direct filter 5 does never slow down. Therefore the threshold level for direct echo cancelling is related to the spectral power of the far end signal x(k) multiplied by an echo reduction function R. It then follows that the step size with regard to the direct echo cancelling may be reduced when Pₛₛ(k) exceeds a threshold level of C′ R Pₓₓ(k), where the echo reduction function for example decays and may start at one and is then adjusted to decay slowly, such that ultimately the direct echo adaptation is slowed down earlier than originally the case.

Principally more than two adaptive filters may be coupled in a series arrangement, whereby each of the adaptive filters have individual adaptation control mechanisms in order to apply their own adaptation strategies. This way each filter is dedicated and can be optimized to cancel a designated part of the echo impulse response.

1. An echo canceller (1) comprising two or more adaptive filters (5, 10) for calculating echo estimates, the adaptive filters (5, 10) each having adaptation control mechanisms (9, 11) for applying individual update control criteria, at least two of the adaptive filters (5, 10) being arranged in series.

2. The echo canceller (1) according to claim 1, characterised in that a first adaptive filter (9) is arranged for cancelling an echo part, and the second adaptive filter (11) is arranged for cancelling at least a remaining echo part.

3. The echo canceller (1) according to claim 1, characterised in that the echo canceller (1) includes a delay element (12) which is coupled to a second or further adaptive filter (10).

4. The echo canceller (1) according to claim 1, characterised in that the first adaptive filter (9) is arranged for cancelling a direct echo, and the second adaptive filter (11) is arranged for cancelling a diffuse echo.

5. The echo canceller (1) according to claim 1, characterised in that the echo canceller (1) comprises threshold means (13, 14) coupled to at least one of the adaptation control mechanisms (9, 11) for reducing the respective step-size if the spectral power of near end speech fed to the echo canceller (1) exceeds a respective threshold level.

6. The echo canceller (1) according to claim 5, characterised in that the threshold level which is applied in the adaptation control mechanism (9, 11) for the direct and/or diffuse echo part is dependent on the spectral power of a far end signal fed to the echo canceller (1).

7. The echo canceller (1) according to claim 6, characterised in that the dependency on the spectral power of the far end signal fed to the echo canceller (1) is a linear dependency through an adjustable coupling factor.

8. The echo canceller (1) according to claim 6, characterised in that the threshold level for direct echo cancelling is related to the spectral power of the far end signal multiplied by an echo reduction function.

9. A telephone, in particular a mobile telephone,comprising an echo canceller (1) according to claim 1.
